(19) United States
(12) Patent Application Publication
(10) Pub. No.: US 2024/0388744 A1
(43) Pub. Date: Nov. 21, 2024

(54) METHOD OF ENABLING ENHANCED CONTENT CONSUMPTION

(71) Applicant: GOOGLE LLC, Mountain View, CA (US)

(72) Inventors: Ramprasad Sedouram, Bangalore (IN); Jaunani Sriramachandran, Chennai (IN)

(21) Appl. No.: 18/266,133

(22) PCT Filed: Jun. 7, 2023
(86) PCT No.: PCT/US2023/024728

§ 371 Date: Jun. 8, 2023

(30) Foreign Application Priority Data
Dec. 9, 2022 (IN) IN202221071160

(51) Int. Cl. H04N 21/234; H04N 21/2387; H04N 21/258; H04N 21/431

(52) U.S. Cl. CPC H04N 21/23418; H04N 21/2387; H04N 21/25891; H04N 21/431

(57) ABSTRACT

Implementations determine, based on account data for an account of a user, target content that is likely to be undesired by the user. Those implementations further determine whether the target content is included in certain content, such as a video or a webpage, that is being rendered or is to be rendered at a client device of the user. Yet further, those implementations perform remediating action(s) in response to determining that the target content is included in the certain content. The remediating action(s) that are performed can reduce or eliminate a quantity of user inputs and/or a duration of time needed for bypassing at least segment(s), of the certain content, that are determined to include the target content.

### BACKGROUND

Users frequently access websites, apps, and/or content-sharing platforms for consumption of content such as videos, audio (e.g., music), slides, and blogs. User consume such content to learn knowledge, to share and communicate, and/or to acquaint themselves with new information. However, when browsing a webpage or viewing a video, a user can often encounter undesired content and/or content that the user has already consumed, even when the webpage or video are responsive to a purposeful search or being recommended/personalized for the user.

In situations where undesired content and/or already consumed content is encountered, rendering of such content can waste computational resources. Further, in attempting to navigate through a webpage or a video to avoid such content, multiple user interface inputs can be required. For example, a user may need to tap and drag on a timeline interface on a video to navigate past such content, and may need to then drag in an opposite direction if they inadvertently navigated past such content. Providing multiple inputs to navigate past such content can be burdensome, especially for users with limited dexterity and/or when a screen, at which such content is being rendered, is of a small size. Further, navigating through such content and/or beyond such content can be time-consuming and/or can utilize client device resources.

### SUMMARY

Implementations described herein are directed to determining, based on account data for an account of a user, target content that is likely to be undesired by the user. Those implementations are further directed to determining whether the target content is included in certain content, such as a video or a webpage, that is being rendered or is to be rendered at a client device of the user. Yet further, those implementations are directed to performing one or more remediating actions in response to determining that the target content is included in the certain content.

The remediating action(s) that are performed can reduce or eliminate a quantity of user inputs and/or a duration of time needed for bypassing at least segment(s), of the certain content, that are determined to include the target content. For example, a remediating action can include automatically skipping a segment of a video in response to determining that the target content is included in the segment, thereby obviating the need for any user input to bypass the segment. As another example, a remediating action can additionally or alternatively include rendering, in a progress bar of a video, marks that indicate a start and an end of a segment of the video determined to include the target content, thereby enabling a user to more quickly interact with the progress bar to skip the segment. As yet another example, a remediating action can include hiding or obfuscating a segment of a webpage determined to include the target content, thereby enabling a user to quickly bypass the hidden or obfuscated segment. Various additional and/or alternative remediating action(s) can be performed, such as those described herein, that can reduce or eliminate a quantity of user input(s) and/or a duration of time needed for bypassing segment(s) of a video or other content.

Further, and as described herein, through utilization of account data of an account of a user in determining target content, remediating action(s) for bypassing the target content will only be performed for a video (or other content) in situations where the account data reflects the target content and the corresponding account is being utilized to view the content. Put another way, remediating action(s) for certain target content in a video (or other content) can be performed when certain users access the video but not when other users access the video. Moreover, a first user accessing the video (or other content) can be associated with first target content and, as a result, remediating action(s) can be performed based on a first segment of the video that is determined to include the first target content. A second user accessing the same video can be unassociated with the first target content but associated with distinct second target content and, as a result, remediating action(s) can be performed based on a distinct second segment of the video that is determined to include the second target content.

As referenced above, target content can be determined, with permission from a user, from account data of an account of the user. In some implementations, the target content can be undesired content that the user has not consumed and prefers to not consume. For example, the target content can be spoiler information of a movie (or a story, a book, etc.) that the user has not watched. The target content can be determined based on account data, of an account of the user, reflecting that the user has not yet watched the movie and/or reflecting that the user has explicitly indicated that they want to avoid the spoiler information before watching the movie. The account data can include preference data such as message data which includes a statement that the user prefers not to consume any spoiler information. Alternatively or additionally, the account data can include historical data indicating that the frequency, of the user in skipping spoiler information, exceeds a frequency threshold.

In some implementations, the target content can be content the user has previously consumed or shared, but can be undesired content as the user does not want to consume the content again. For instance, the target content can be a feature of a tool for which the user is already familiar. Account data of the user can reflect that the user is already familiar with the feature. For example, the account data can include indications of the user having previously visited webpage(s) describing the feature, and/or having previously issued search(es) related to the feature, having previously viewed video(s) describing the feature. Accordingly, the user can be well aware or have a sufficient understanding of the feature, so that repeated consumption (e.g., a video clip or a portion of an article that introduces the same feature) of content that introduces or discusses the feature not only deteriorates the user experience of the user, but also leads to unnecessary utilization of computing resources and battery resources. Optionally, the account data can include or otherwise be determined based on, for example, emails or other messages including past transactions/events the user made or attend, application data that indicates content already consumed by the user, location data, photos and screenshots (from which text or images can be processed to identify relevant entities or other objects), and/or other resources.

Implementations disclosed herein enable a user to more efficiently navigate through a video, a webpage, or other media content, and/or to selectively consume portions of the video or portions of the webpage without encountering undesired content for the user. This, in turn, saves computing and battery resources of a client device via which the video or the webpage is rendered since, for example, less operations are received from the user, and since the video (or the webpage) does not need to be rendered by the client device in its entirety.

The above description is provided as an overview of only some implementations disclosed herein for the sake of example. Those implementations, and other implementations, are described in additional detail herein.

It should be understood that techniques disclosed herein can be implemented locally on a client device, remotely by server(s) connected to the client device via one or more networks, and/or both.

### BRIEF DESCRIPTION OF THE DRAWINGS

FIG. 1 depicts a block diagram of an example environment that demonstrates various aspects of the present disclosure, and in which implementations disclosed herein can be implemented.

FIG. 2A, FIG. 2B, 2C, FIG. 2D, FIG. 2E, FIG. 2F, FIG. 2G, and FIG. 2H illustrate non-limiting examples of rendering a content alert for target content in response to determining that the target content is included in a video or in other content), in accordance with various implementations.

FIG. 3A, FIG. 3B, and FIG. 3C illustrate another non-limiting example of rendering a content alert for target content in response to determining that the target content is included in a video, in accordance with various implementations.

FIG. 4A depicts a flowchart illustrating an example method of alerting a user of target content, in accordance with various implementations.

FIG. 4B depicts a non-limiting example of block 403 of the flowchart of FIG. 4A.

FIG. 5 depicts a flowchart illustrating another example method of alerting a user of target content, in accordance with various implementations.

FIG. 6 depicts an example architecture of a computing device, in accordance with various implementations.

### DETAILED DESCRIPTION

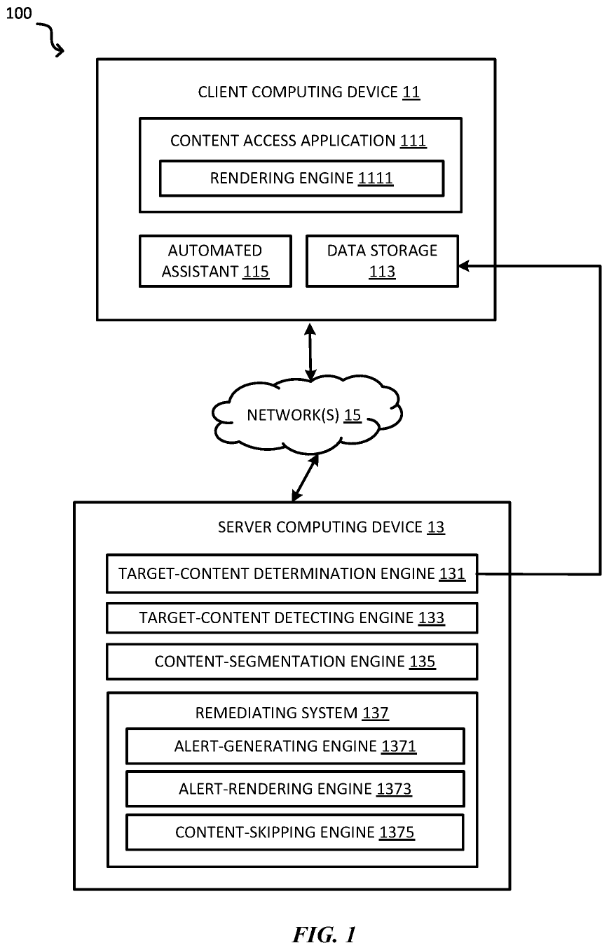

FIG. 1 provides a block diagram of an example environment 100 that demonstrates various aspects of the present disclosure, in which implementations disclosed herein can be implemented. The example environment 100 includes a client computing device (sometimes referred to as “client device”) 11, and a server computing device 13 in communication with the client device 11 via one or more networks 15. The one or more networks 15 can include, for example, one or more wired or wireless local area networks (“LANs,” including Wi-Fi LANs, mesh networks, Bluetooth, near-field communication, etc.) or wide area networks (“WANs”, including the Internet).

The client device 11 can be, for example, a cell phone, a computer (e.g., laptop, desktop, notebook), a tablet, a robot having an output unit (e.g., screen), a smart appliance (e.g., smart TV), an in-vehicle device (e.g., in-vehicle entertainment system), a wearable device (e.g., glasses), a virtual reality (VR) device, or an augmented reality (AV) device, and the present disclosure is not limited thereto. In various implementations, the client device 11 can include a content access application 111, that is installed locally at the client device 11 or is hosted remotely (e.g., by one or more servers) and can be accessible by the client device 11 over the one or more networks 15.

As non-limiting examples, the content access application 111 can be a media player (e.g., movie player, music player, etc.), a web browser, a social media application, a reader application (e.g., PDF reader, e-book reader), or any other appropriate application, that allows a user of the client device 11 to access, consume, and/or share content such as text, images, slides, audio, and/or videos. Optionally, the content access application 111 can include a content-rendering engine 1111 (sometimes referred to as “rendering engine”) that renders the content (e.g., text, images, etc.) via a user interface (e.g., graphical or audible user interface) of the client device 11. The content-rendering engine 1111 can be configured to render the content for audible and/or visual presentation to a user of the client device 11 using one or more user interface output devices (e.g., speakers, display, etc.). For example, the client device 11 may be equipped with one or more speakers that enable audible content to be rendered to the user via the client device 11. Additionally or alternatively, the client device 11 may be equipped with a display or projector that enables visual content to be rendered to the user via the client device 11.

In various implementations, the client device 11 can include data storage 113. The data storage 113 can store various types of data, including but is not limited to: account data for an account of a user (e.g., that can include or be based on user preference data, user historical data) that may or may not be associated with one or more applications accessible by the client device 11, device data associated with the client device 11, sensor data collected by sensors of the client device 11.

Optionally, the client device 11 can include, or otherwise access an automated assistant 115 (sometimes referred to as “chatbots,” “interactive personal assistants,” “intelligent personal assistants,” “personal voice assistants,” “conversational agents,” or simply “assistant,” etc.). For example, humans (who when they interact with automated assistants may be referred to as “users”) may provide commands/requests to the automated assistant 115 using spoken natural language input (i.e., spoken utterances), which may in some cases be converted into text and then processed, and/or by providing textual (e.g., typed) natural language input. The automated assistant 115 can respond to a command or request by providing responsive user interface output (e.g., audible and/or graphical user interface output), controlling smart device(s), and/or performing other action(s).

The server computing device 13 can be, for example, a web server, a proxy server, a VPN server, or any other type of server as needed. In various implementations, the server computing device 13 can include a target-content determination engine 131, a target-content detecting engine 133, a content-segmentation engine 135, and a remediating system 137, where the remediating system 137 can include an alert-generating engine 1371, an alert-rendering engine 1373, and/or a content-skipping engine 1375.

In various implementations, the target-content determination engine 131 can determine target content to be skipped (or otherwise to be hidden, removed, obfuscated, etc.). In various implementations, the target-content determination engine 131 can rely on account data to determine the target content to be skipped. For example, the target-content determination engine 131 can retrieve, from the data storage 113, preference data that indicates a user's preference to not receive spoiler information of one or more particular types of media content (e.g., movies, theaters, TV series, books, audio books, etc.) In this example, the target-content determination engine 131 can, based on the preference data, determine spoiler information of movies as the target content to be skipped. As another example, the target-content determination engine 131 can retrieve user historical data that indicates a user has accessed certain content (e.g., how to make wonton wrappers for cooking dumplings) from the data storage 113. In this example, based on the user historical data, the target-content determination engine 131 can determine content the same as (or similar to) the certain content (e.g., how to make wonton wrappers) as the target content to be skipped. As a further example, the target-content determination engine 131 can retrieve user historical data and/or preference data that indicate a user prefers to not receive spoiler information of a particular movie the user hasn't watched (or a particular book, a particular TV series, etc.). In this example, based on the user historical data and/or preference data, the target-content determination engine 131 can determine spoiler information of the particular movie the user hasn't watched as the target content to be skipped.

In various implementations, the target-content detecting engine 133 can detect the target content from a webpage that contains multimedia content (textual, graphical, animation, video, slides, etc.), from a video displayed by a stand-alone media player, from a user interface of a social media application, or from any other appropriate sources that provide content consumption. As a non-limiting example, given spoiler information of “movie X” as the target content to be skipped, the target-content detecting engine 133 can process one or more videos and detect that a first video, of the one or more videos, includes spoiler information of the movie X. In this example, the target-content detecting engine 133 can further process the first video that includes the spoiler information of the movie X, to determine a video segment (of the first video) that includes the spoiler information of the movie X. For instance, the target-content detecting engine 133 can determine a starting point (e.g., approximately 20 s) and an ending point (e.g., approximately 35 s) of the video segment in the first video. In this case, optionally or additionally, the content-segmentation engine 135 can divide/segment the first video into a plurality of video segments using the starting and ending points of the video segment that includes the spoiler information of the movie X.

As another non-limiting example, given textual content that describes “how to make wonton wrappers” as the target content to be skipped, the target-content detecting engine 133 can process one or more documents (e.g., webpage), and detect that a first document, of the one or more documents, includes textual content that describes “how to make wonton wrappers”. In this example, the target-content detecting engine 133 can further process the first document, to determine from the first document a textual segment that describes “how to make wonton wrappers”. For instance, the target-content detecting engine 133 can determine a starting point (e.g., approximately 600 pixels from a top edge of the document and/or 200 pixels from a left edge of the document) and an ending point (e.g., approximately 850 pixels from the top edge of the document and/or 480 pixels from the left edge of the document) for the textual segment (that describes “how to make wonton wrappers”) in the first document. In this case, optionally or additionally, the content-segmentation engine 135 can divide/segment the first document into a plurality of textual segments using the starting and ending points of the textual segment that describes “how to make wonton wrappers”.

In various implementations, after the target-content detecting engine 133 detects the target content, the remediating system 137 can take one or more remediating actions. The one or more remediating actions can include but are not limited to: a first action of displaying a content alert for the target content, a second action of automatically skipping the target content, and/or a third action of displaying a selectable element that allows a user to manually skip (or keep) the target content.

In some embodiments, the remediating system 137 can include the alert-generating engine 1371, where the alert-generating engine 1371 can generate a content-alert label based on a type of the target content. For example, the alert-generating engine 1371 can generate a spoiler-alert label (e.g., “spoiler alert”) based on the target content being spoiler information. Optionally or additionally, the alert-generating engine 1371 can generate detailed alert information (e.g., “This video contains spoilers of movie X that you have yet to watch”) in natural language. The alert-rendering engine 1373 can render the content-alert label and/or the detailed alert information visually or audibly via the client device 11.

In some embodiments, the content-skipping engine 1375 can cause the target content to be skipped, hidden, removed, or obfuscated when media content, that includes such target content, is rendered via the client device 11. As a non-limiting example, the content-skipping engine 1375 can cause the target content to be skipped automatically. As another non-limiting example, the content-skipping engine 1375 can generate a slider control having a slider configurable at a plurality of positions. The plurality of positions can include a first position, at which when the slider is configured, corresponds to an “ON” status that indicates that a content-skipping function is turned on. The plurality of positions can include a second position, at which when the slider is configured, corresponds to an “OFF” status that indicates that the content-skipping function is turned off. Whenever the slider control is displayed for user interaction, a user can move the slider of the slider control from the first position to the second position, which causes the content-skipping function to be turned off. Or, the slider can be moved from the second position to the first position, which causes the content-skipped function to be turned on. The content-skipping engine 1375 can cause the slider control to be rendered along with the detailed alert information (and/or along with the content-alert label). In this case, if user input, that is directed to the slider control and that turns off the skipping function, is received, the target content will not be skipped. Or, if no user input is received, the target content can be automatically skipped. Alternatively, instead of a slider control having a slider movable to turn on or turn off the content-skipping function, the content-skipping engine 1375 can generate a selectable button having a default “ON” status (reflected by the selectable button displaying a term “ON” in for example green color), where when the selectable button is selected, the selectable button can replace the term “ON” with a term “OFF” (which can be in gray or red color for instance), indicating that the content-skipping function has been turned off.

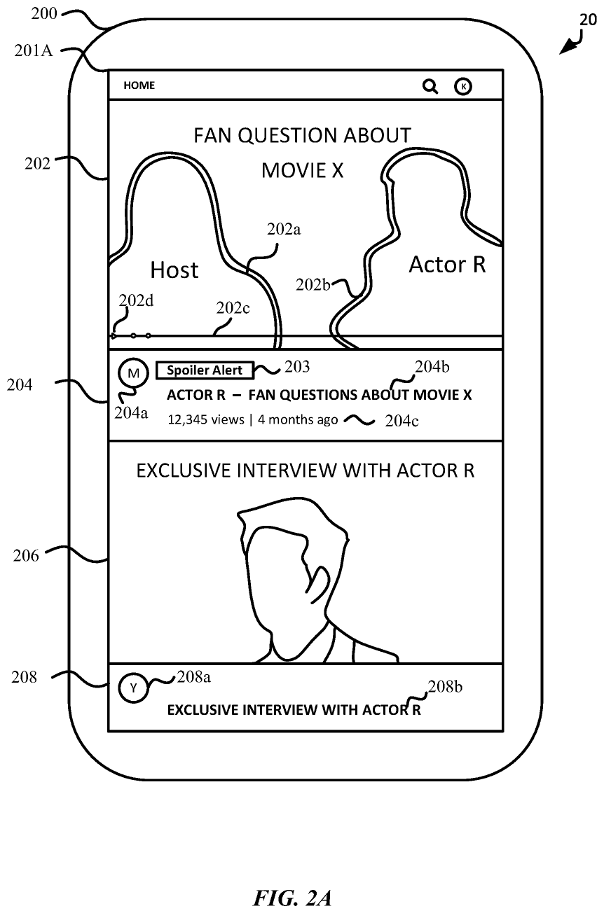

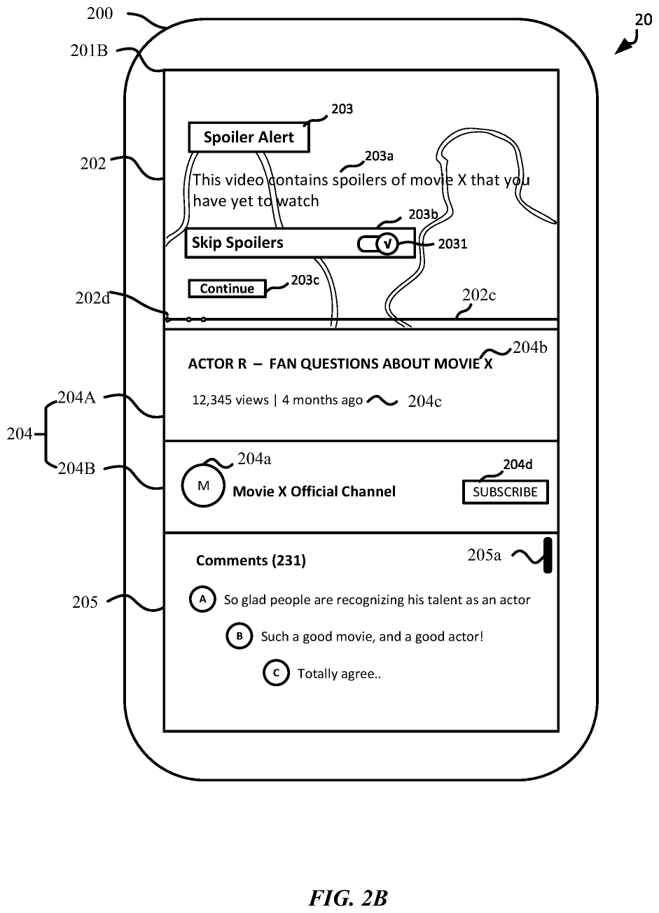

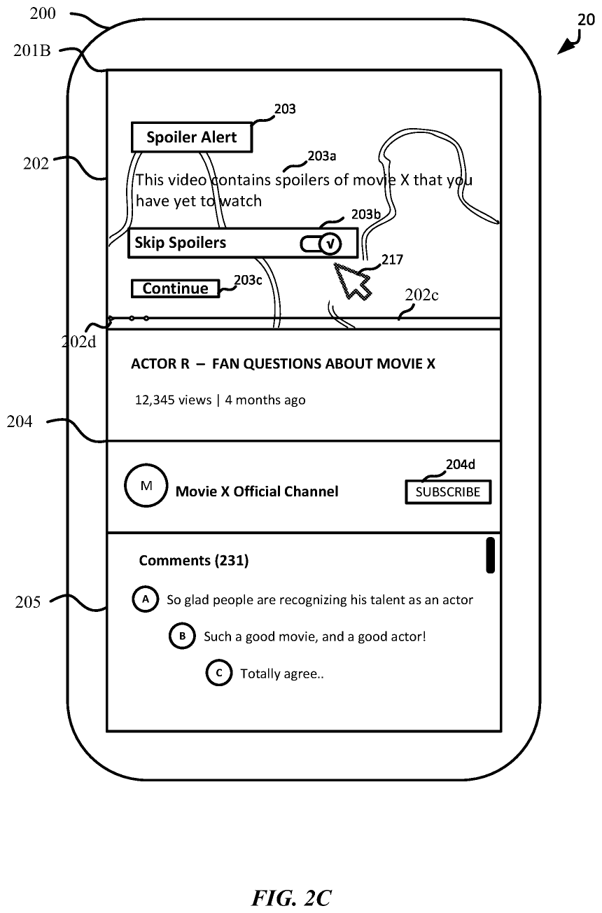

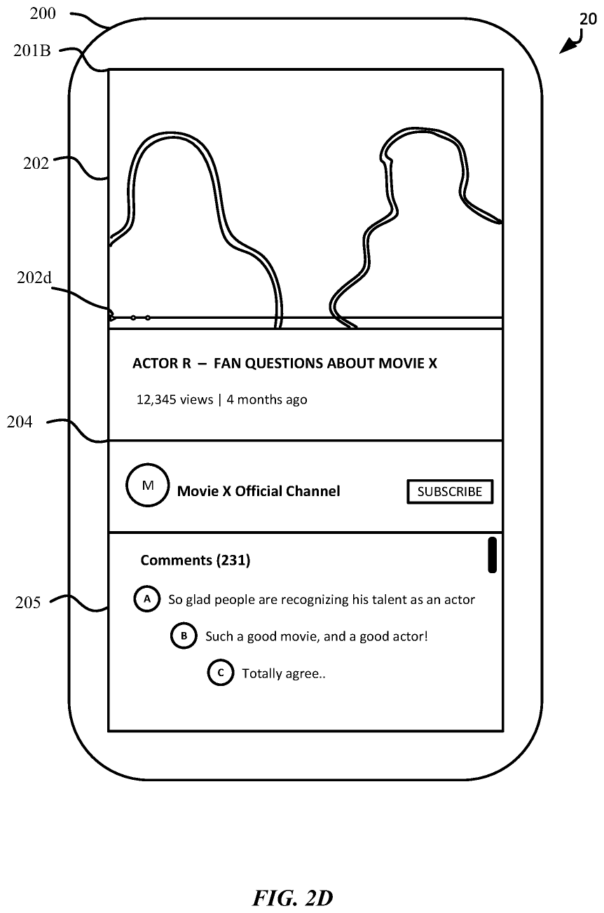

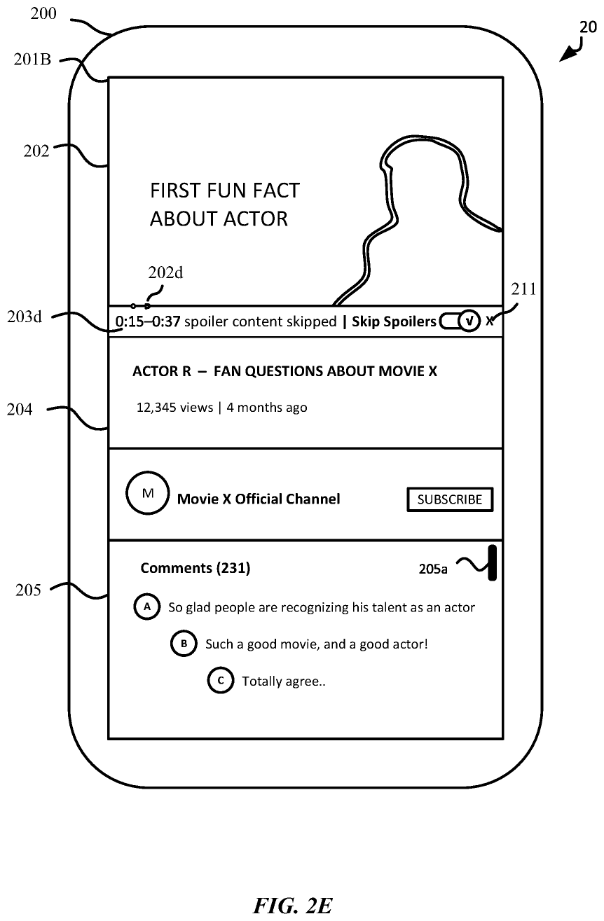

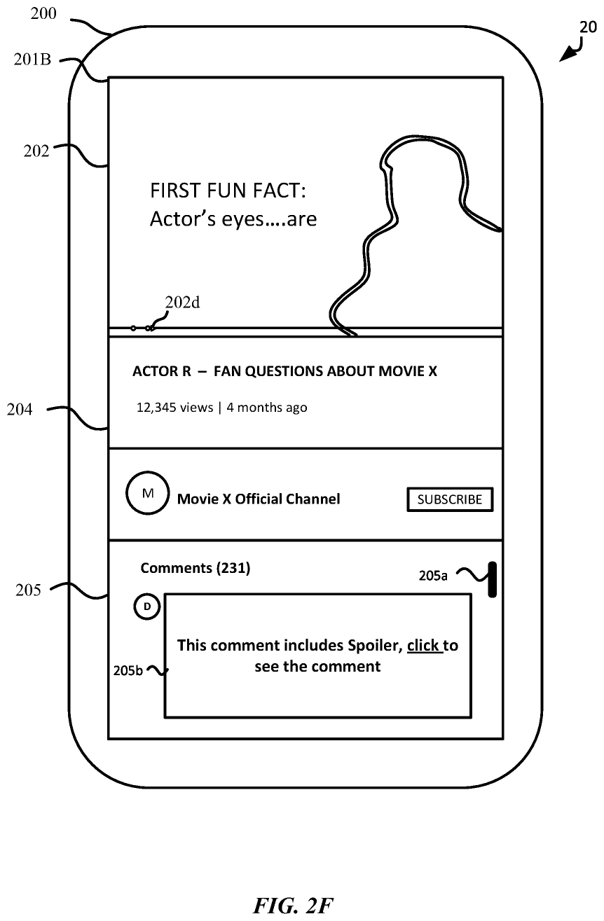

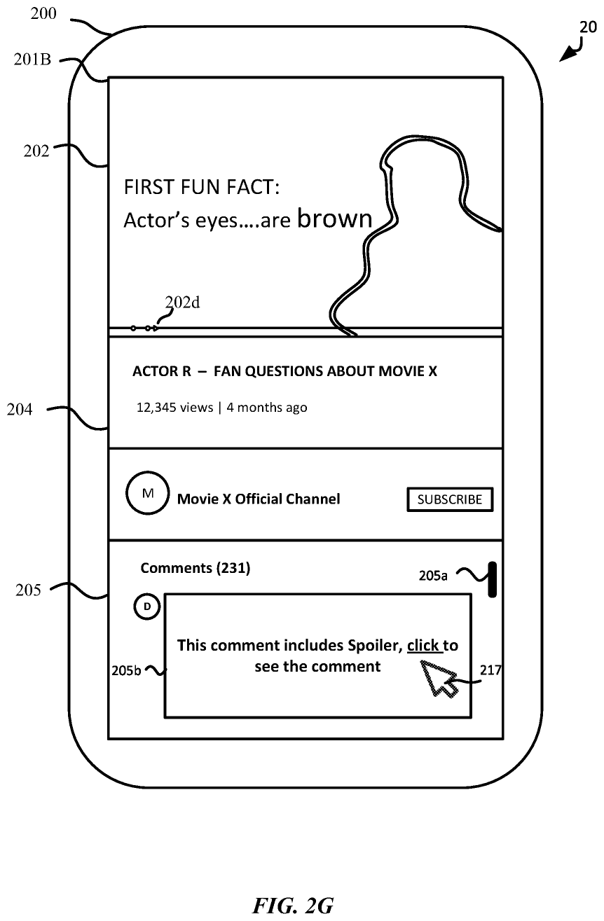

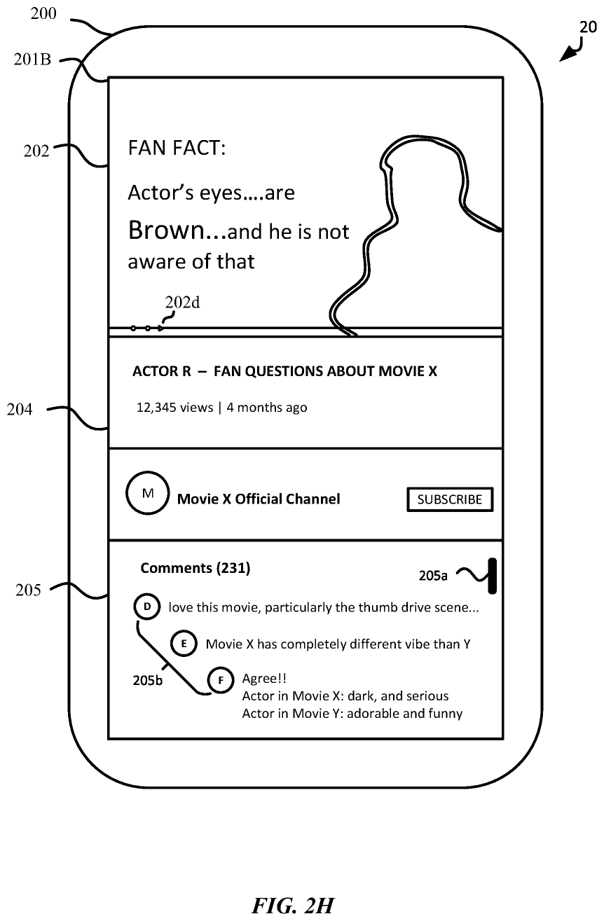

FIGS. 2A, 2B, 2C, 2D, 2E, 2F, 2G, and 2H illustrate a non-limiting example of displaying content alert for undesired content of a website that is rendered to a user via a display, in accordance with various implementations. As shown in FIG. 2A, a user of a client device 200 (e.g., a cellphone) may use a content-access application to access media content (e.g., one or more videos), where a user interface 201A of the content-access application can display one or more videos or can display thumbnails (or previews) of multiple videos for the user to select and watch one of the multiple videos. For instance, referring to FIG. 2A, the user interface 201A of the client device 200 can display a thumbnail of a first video 202 and a thumbnail of a second video 206.

In some implementations, the first video 202 and the second video 206 can be videos personalized based on account data (e.g., browsing history, searching history, preference), for recommendation to the user of the client device 200. In some implementations, the first video 202 and the second video 206 can be videos obtained as search results for a search conducted by the user. In some implementations, the first video 202 is a video selected by the user to watch, and the second video 206 is a video recommended to the user based on content of the first video 202 and/or other data. Optionally or alternatively, the user interface 201A of the client device 200 can display thumbnails of more than two videos. Optionally or alternatively, the content-access application is a stand-alone media player, and the user interface 201A of the client device 200 displays one and only one video. The implementations and their variations described here are for illustrative purposes, and are not intended to be limiting.

Referring to FIG. 2A, the thumbnail of a first video 202 can include/display an image from a first video frame (or a representative video frame) of the first video 202, where the image features a first character 202a (“host”) interviewing a second character 202b (“actor R”) for fan questions about movie X. In some implementations, optionally, in response to the user of the client device 200 manipulating a pointer (e.g., mouse cursor, not shown) to hover over the first video 202 or the thumbnail of the first video 202, a progress bar 202c can be displayed, where the progress bar 202c can disappear if movement of the pointer is not detected within a predefined time window since the display of the progress bar 202c.

Optionally, the progress bar 202c can indicate that the first video 202 is divided into a plurality of video segments. Optionally, the progress bar 202c can indicate a length (e.g., 10 min) of the first video 202. Optionally, the progress bar 202c can include an indicator 202d (e.g., time indicator), where the indicator 202d can indicate the time (e.g., 1:33 min) at which a current video frame is displayed via the user interface 201A. Optionally, a position of the indicator 202d can be adjusted along the progress bar 202c, to start the first video 202 from a particular video frame to which the position of the indicator 202d corresponds.

Optionally, the user interface 201A of the client device 200 can further display an information region 204 of the first video 202, where the information region 204 can include a channel icon 204a of a channel (or a user account) that provides the first video 202, a title 204b of the first video 202, and other information 204c (e.g., the number of times the first video 202 is viewed, the publication date of the first video 202, etc.) of the first video 202. Similarly, the user interface 201A of the client device 200 can optionally display an information region 208 of the second video 206, where the information region 208 can include a channel icon 208a of a channel (or a user account) that provides the second video 206, a title 208a of the second video 206, and/or other information (not shown) of the second video 206.

Referring to FIG. 2A, the first video 202 can be a video in which actor R is being interviewed for fans' questions about his most recently released movie X, and the second video 206 can be a video in which actor R is being interviewed for his childhood, family, and hometown. In this case, a content-alert label 203 (e.g., a spoiler-alert label) can be displayed for the first video 202, while no content-alert label is displayed for the second video 206. Here, the content-alert label 203 can display “Spoiler Alert” in its natural language format. Optionally or additionally, the content-alert label 203 can include a background color (e.g., yellow) that distinguishes the content-alert label 203 from other portions of the user interface 201A. Optionally, as a non-limiting example, the content-alert label 203 can be displayed in the information region 204.

In some implementations, the content-alert label 203 can be generated by the aforementioned remediating system based on target content (e.g., spoiler information) detected from the first video 202. For example, account data associated with the content-access application 200 or other apps, and/or other account data associated with the client device 20, can indicate that the user of the client device 20 has not watched the movie X (and/or that the user of the client device 20 prefers to not receive any spoiler information of movies she hasn't watched). For instance, when account data (from, e.g., ticket-booking apps, mails, bookmarks collecting videos to watch or saved for later, wallet apps, transaction records, SMS's, content-browsing and upload history, location information) shows that the user has no electronic communication with electronic ticket or order receipt attached (or contained) for a particular movie, no ticket transaction for the particular movie, and/or no visit to the cinema (based on location data), it can be determined that the user likely has not watched the particular movie. In this case, spoiler information of the movie X (or, spoiler information of movie X and other movies) can be determined (e.g., by the aforementioned target-content determination engine) as the target content, where the determined target content is to be skipped or where the display of such target content is to be modified (hidden, removed, obfuscated, etc.).

Given that the spoiler information of the movie X as the target content to be skipped (for playing), videos such as the first video 202 and the second video 206 can be processed to determine whether they contain any target content. Here, the processing of the first video 202 can lead to the detection of one or more video segments containing spoiler information of movie X, which means target content is detected from the first video 202. The processing of the second video 206 can lead to the detection of no spoiler information of movie X from the second video 206, which means target content is not detected from the second video 206. Based on the target content being detected from the first video 202 but no target content being detected from the second video 206, the content-alert label 203 can be generated for the first video 202 and not for the second video 206.

Referring to FIG. 2B, the user of the client device 200 may decide to watch the first video 202 by selecting the first video 202, where in response to the user selecting the first video 202, a user interface 201B of the content-access application can be displayed at the client device 200. The user interface 201B can include the content-alert label 203 and/or detailed alert information associated with the content-alert label 203, displayed as an overlay of a first video frame of the first video 202. Here, the content-alert label 203 and/or detailed alert information associated with the content-alert label 203 can be displayed before the first video 202 starts playing. Alternatively, the content-alert label 203 and/or detailed alert information associated with the content-alert label 203 can be displayed some time before (e.g., one video frame before, or a few video frames before) the spoiler information is displayed in the first video, and the present disclosure is not limited thereto.

As a non-limiting example, the detailed alert information associated with the content-alert label 203 can include: a text 203a that describes the target content (i.e., target content to be alerted) detected from the first video 206 and a graphical element 203b, and/or a button 203c. Here, the button 203c can be a selectable button, when selected, initiates the first video 202. Further, the graphical element 203b can include a slider control 2031 and/or a textual portion (“skip spoilers”) that describes a function/purpose of the slider control 2031, where the slider control 2031 can include a sliding track and a slider (sometimes referred to as a “thumb”, indicated using a tick mark) that moves along the sliding track.

In various implementations, the slider can be moved along the sliding track into a plurality of positions, where the plurality of positions can include a first (e.g., the left-most) position that corresponds to an “turned-off” status of the function of the slider control 2031 (i.e., the “skip spoilers” function) and a second (e.g., the right-most) position that corresponds to an “turned-on” status of the function of the slider control 2031 (i.e., the “skip spoilers” function). In these implementations, when the slider is moved from the first position to the second position, the status of the function of the slider control 2031 can vary from the “turned-off” status into the “turned-on” status, meaning that the “skip spoilers” function is turned on. Similarly, when the slider is moved from the second position to the first position, the status of the function of the slider control 2031 can vary from the “turned-on” status into the “turned-off” status, meaning that the “skip spoilers” function is turned off. In some implementations, the sliding track can be configured as a straight track. Alternatively, the sliding track can be configured as a curved track.

Optionally, when the user interface 201B of the content-access application is displayed in response to the user selecting the first video 202, the slider of the slider control 2031 displayed at the user interface 201B can be in a default “ON” (i.e., “turned-on”) position (e.g., the right-most position) indicating that the “skip spoilers” function is automatically turned on. In this case, if the user selects the button 203c to initiate the first video 202, the spoiler alert 203 (and the associated detailed information, if there is any) disappears from the user interface 201B of the content-access application, and the first video 202 starts playing at the user interface 201B, where video segments of the first video 202 containing spoiler information of movie X will be automatically skipped. If the user drags the slider (e.g., using the mouse cursor 217 shown in FIG. 2C) to the first position (the “OFF” or “turned-off” position/status) before selecting the button 203c, the video segments of the first video 202 that contain the spoiler information of movie X will not be skipped when the first video 202 is being played.

Optionally, in some implementations, the user interface 201B can include a progress bar, the same as or similar to the aforementioned progress bar 202c. Optionally, in some implementations, the user interface 201B can include a video/channel section 204, where the video/channel section 204 can include a video section 204A and a channel section 204B. The video section 204A can include the aforementioned title 204b (e.g., “Actor R—FAN QUESTIONS ABOUT MOVIE X”) of the first video 202, and the channel section 204B can include the aforementioned channel icon 204a of a channel (or an owner account, e.g., “M”) that collects the first video 202, and a subscribe button 204d which, when selected, causes an account of the content-access application of the user to subscribe to the channel “M”.

Optionally, in some implementations, the user interface 201B can include an interaction region 205 in which viewers of the first video 202 can interact with an owner of the channel “M” and/or other viewers, by leaving one or more comments and receiving replies (if any) from the owner of the “M” and/or other viewers. The one or more comments and the receiving replies (if any) can be displayed at the interaction region 205, and if the total number of the one or more comments and/or the receiving replies exceeds a predefined threshold, a scroll-bar 205a can be displayed within the interaction region 205 for the user of the client device 200 to navigate through the comments and/or replies.

Referring to FIG. 2D, the first video 202 can start playing, where the user interface 201B can display a first video frame of the first video 202. When the user interface 201B displays the first video frame of the first video 202, the time indicator 202d can be in an initial position indicating a current progress of the first video 202 is 0% (or indicating the time, to which the first video frame corresponds and for how long the first video 202 has been displayed, is approximately 0:00 min). Referring to FIG. 2E, after the first video 202 has been played for 15 seconds, the first video 202 can skip video content (e.g., the target content that contains the spoiler information of movie X) for the next 22 seconds, to provide video content of the first video 202 starting from the 37 seconds. Here, the video content between the 15 seconds and the 37 seconds (i.e., the target content containing the spoiler information of movie X) can be an official trailer of movie X, a video segment about the Actor R discussing his role and/or a particular scene in move X, an image showing a filming location at which a movie scene is created, or contain other information the user may not want to know before watching movie X.

In various implementations, as shown in FIG. 2E, a textual message 203d can be displayed adjacent to (e.g., below, above) the progress bar 202c. The textual message 203d can include a textual portion notifying that the spoiler information (or a portion thereof, in case the spoiler information is distributed discontinuously over the first video 202) has been skipped, e.g., “0:15˜0:37 skipped due to spoiler content”. Optionally or additionally, the textual message 203d can include the aforementioned slider control and/or the associated textual portion (“skip spoilers”) that describes a skipping function of the slider control. In this case, if the user drags the slider to its “OFF” position, subsequent spoiler information (if any) will not be skipped, in other words, the rest of the first video 202 that starts from approximately 0:37 min will be played without automatic skipping of the subsequent spoiler information of movie X.

The textual message 203d can be displayed, for instance, in response to determining that the first video 202 includes target content (e.g., the spoiler content starting from a time point of 0:15 min and ending at a time point of 0:37 min). Optionally, the textual message 203d can be displayed statically. In this case, the user can remove the textual message 203d from displaying by clicking on a symbol or button 211 that causes the textual message 203d from not being displayed. Optionally, the textual message 203d can be removed from displaying after the spoiler content is skipped, or can be removed after being displayed for a certain period of time. In this case, the textual message 203d can, for instance, be shown/triggered in response to detecting a cursor, such as the mouse cursor illustrated in FIG. 2C, hovering over the progress bar 202c. The textual message 203d, however, can be displayed in other applicable manners not specifically described herein.

In various implementations, the aforementioned content alerting/skipping technique can be applied to textual content, instead of, or in addition to, the video content. As a non-limiting example, referring to FIG. 2F, the user of the client device 200 may decide, at approximately 0:38 min, to check out the comments displayed at the interaction region 205 of the user interface 201B. In this example, since the total number of comments (e.g., 231) far exceeds the predefined threshold (e.g., 3), the user after reading comments A˜C (see FIG. 2D), may scroll down using the scroll-bar 205a to see more comments (e.g., comment D). Here, the comment D may be detected using the aforementioned target-content detecting engine as including additional spoiler information of movie X. Correspondingly, before being displayed to the user, the comment D may be hidden (or obfuscated) using an alert message 205b (“This comment includes a Spoiler, click to unveil)” displayed over the comment D, or alternatively, the comment D can be folded and the user has to unfold the comment D to access content of the comment D. Optionally, the alert message 205b (or, a portion thereof which corresponds to the term “click”) can be selectable, and when selected, unveil the content of the comment D. Referring to FIG. 2G, the alert message 205b can be selected (e.g., clicked) using the cursor 217, or can be selected using a spoken utterance (received by the aforementioned automated assistant) that captures the term “click”.

Referring to FIG. 2H, after the user selects the alert message 205b to unveil the comment D, the comment D (e.g., “I love this movie, particularly the thumb drive scene . . . ”) and other comments or replies (e.g., replies E and F, if there are any) that contain spoiler information of movie X can be displayed to the user.

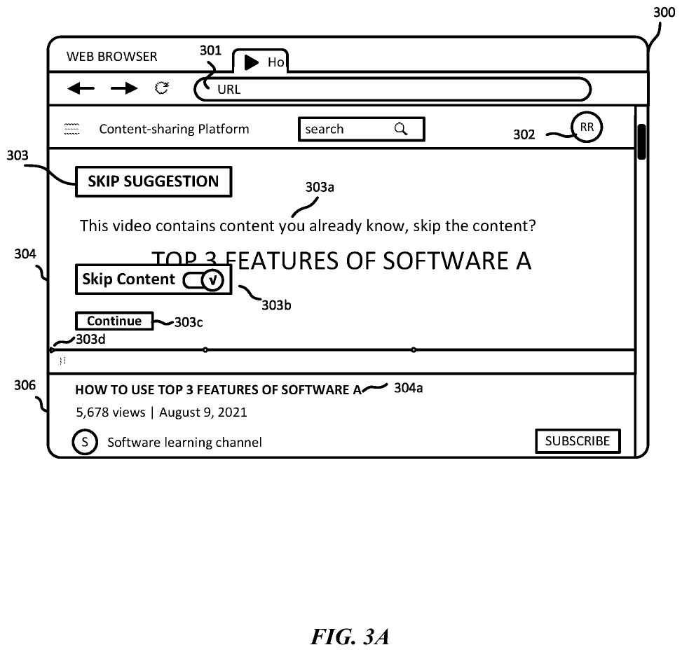

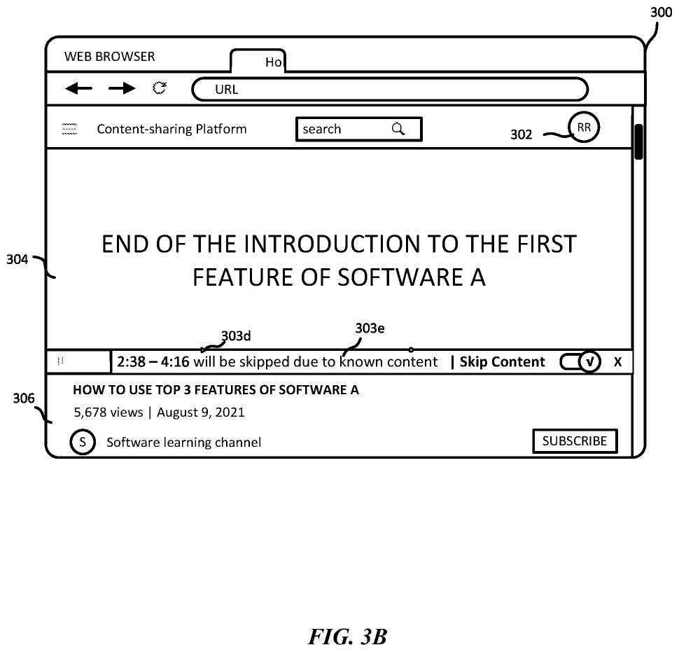

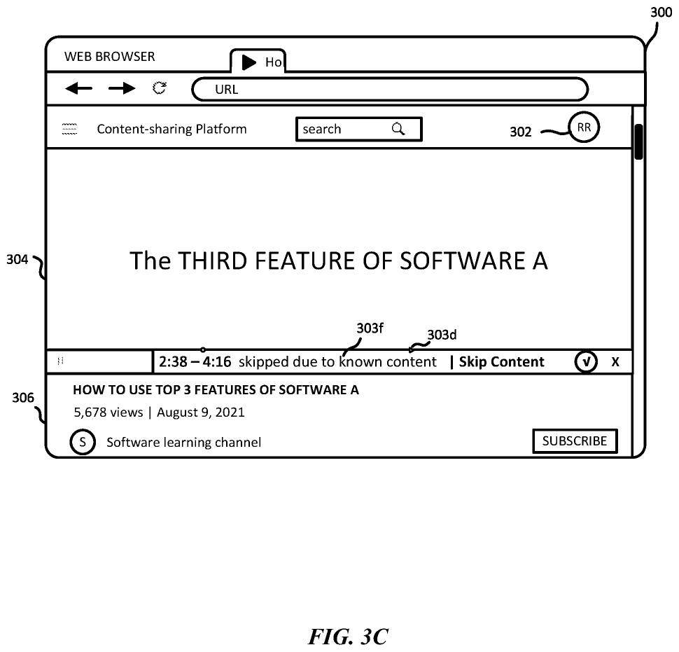

FIGS. 3A, 3B, and 3C illustrate another non-limiting example of displaying content alert for undesired content or target content, in accordance with various implementations. As shown in FIG. 3A, a user RR of a content-sharing platform may use may use a web browser of the client device 300 (e.g., a laptop) to access the content-sharing platform, in order to watch a video 304 titled “How to use top 3 features of software A”, where the video can be shared by an owner or administrator of a channel/account named “S learning channel” (shortly known as channel “S”). Based on account data of the user RR (e.g., the user has uploaded a recording of her that introduces one of the 3 features of software A mentioned in the video 304), the aforementioned target-content determination engine can access content of the video 304 using an address (e.g., URL 301) of the video 304, and process the content of the video 304 to determine that the video 304 includes target content (i.e., target content to be ignored or skipped) that the user RR does not want to spend time on.

In this case, before the video 304 starts playing, an initial video frame of the video 304 at time 0 (indicated by an initial position of the time indicator 303d) can be obfuscated (and/or set as background image), where an alerting interface that includes a skip-alert label 303 (e.g., “SKIP ALERT”, which can be optionally omitted), a skip-alert description 303a (e.g., “This video contains content you already know, skip?”) that describes the target content (i.e., target content to be alerted) detected from the first video 304, a graphical element 303b, and/or a “Continue” button 303c, can be displayed. Similar to the graphical element 203b, the graphical element 303b can include a slider control and/or a textual portion (“Skip content”) that describes a content-skipping function of the slider control. Repeated descriptions of the graphical element 203b are omitted herein.

If the user RR selects the “Continue” button 303c to initiate the playing of the video 304, referring to FIG. 3B, when the video 303 has been played for 2:38 min (indicated by a first intermediate position of the time indicator 303d) during which a first feature of the software A is introduced, a first alerting message 303e can be displayed. The first alerting message 303e can alert the user RR that a portion (e.g., 2: 38˜4:14 min) of the video 304 includes target content (i.e., content known to the user RR) and that the portion will be skipped. Here, the target content can be an introduction to the second top feature of the software A, for which the user RR herself has created and uploaded a recording for share via the content-sharing platform. In this case, the first alerting message 303e can additionally include a slider control that is automatically configured in an “ON” status for a content-skipping function of the slider control. The display of the slide control may allow the user RR to move a tick mark of the slider control to the left, to turn off the content-skipping function of the slider control, so that the target content will not be skipped (in case the user RR wants to go over the second top feature of software A). Optionally, as a non-limiting example, instead of being displayed right before the portion of the video 304 that contains the target content is to start, the first alerting message 303e can be displayed, say 5 seconds, before the portion of the video 304 that contains the target content starts. In this example, the first alerting message 303e can be displayed for 4 seconds or approximately 5 seconds before disappearing automatically, but the present disclosure is not limited thereto.

If the user RR before selecting the “Continue” button 303c to initiate the playing of the video 304, leaves the slider control in the “ON” status (which means the content-skipping function of the slider control is turned on), when the video 304 has been played for 2:38 min, the video 304 will skip the portion originally to be displayed between 2:38 min and 4:16 min, to provide video content that is immediately subsequent to the 4:16 min. Referring to FIG. 3C, in response to the video being displayed for 2:38 min, the time indicator 303d jumps from the first intermediate position (which corresponds to the 2:38 min) to a second intermediate position that corresponds to the 4:16 min, and starting from 4:16 min, a third top feature of software A is introduced in the video 304. Optionally or additionally, a confirmation message 303f (e.g., 2:38-4:16 skipped due to known content) pops up to notify the user RR that a portion of the video 304 is skipped. In this case, video content of the video 304 that introduces the second top feature of software A is skipped. Optionally, the confirmation message 303f can include the slider control if a remaining portion of the video 304 includes any undesired content (e.g., content already known by the user RR).

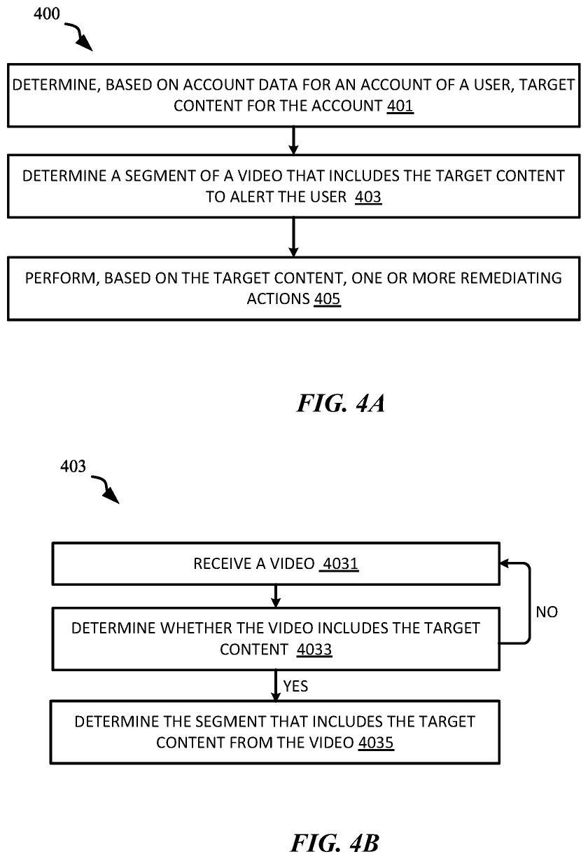

FIG. 4A depicts a flowchart illustrating an example method 400 of alerting a user of target content, in accordance with various implementations. FIG. 4B depicts a flowchart illustrating the detection of target content from media content (e.g., a video), in accordance with the example method 400 and various implementations. For convenience, the operations of method 400 are described with reference to a system that performs the operations. The system of method 400 includes one or more processors and/or other component(s) of a client device and/or of a server device. Moreover, while operations of the method 400 are shown in a particular order, this is not meant to be limiting. One or more operations may be reordered, omitted, or added.

As shown in FIG. 4A, in various implementations, a method 400 of alerting a user of target content can be performed by a system, where at block 401, the system determines, based on account data of an account of a user, target content for the account. Here, depending on the account data, the target content can be information undesired to the user, contained in one or more videos or video segments (and audio accompanying the one or more video segments), one or more words of a text, an image or a portion thereof, au audio piece of an audio, or any combination thereof. For instance, the target content can be spoiler information of a particular movie that the user has not watched, or the target content can be spoiler information of all movies that the user has not watched. However, the target content is not limited to spoiler information of movie(s) that the user desires not to watch before she actually watches the movie, and can be any other applicable type of data or information the user prefers not to encounter.

The account data can, for instance, include preference data indicating that a user prefers not to encounter any spoiler information of a video (alternatively, of any videos). As a non-limiting example, the preference data can include (or otherwise be determined from) preference settings associated with an application or a client device, textual or audio data communicated or recorded using one or more applications (such as a messaging application, a calendar application, a note-taking application, etc.) regarding preference(s) of the user, and/or other applicable data. As another non-limiting example, the account data can include user historical data, where the user historical data can indicate content known to a user (e.g., content a user has browsed, shared, and/or created).

As a further non-limiting example, the account data can include: (1) historical data indicating content known to a user and/or content not known to the user, and (2) preference data indicating user preference to ignore the content known to the user (or to review again the content known to the user) and/or user preference to ignore certain content from the content not known to the user. Based on such account data, the system can determine the content known to the user and/or content not known but undesired to the user as the target content to alert the user. Optionally, the account data can include other metadata associated with the user and are not limited to the preference data and historical data described herein.

In various implementations, at block 403, the system can determine, from a video, a video segment that includes the target content (to alert the user). For instance, the system can determine that a video clip (i.e., “video segment”) of a video, from a plurality of videos, includes spoiler information of a particular movie, where the account data of the account of a user indicates that such spoiler information of the particular movie is target content undesired to see or watch by the user. In some versions of these implementations, referring to FIG. 4B, to determine the segment (of the video) that includes the target content (403), the system can, at block 4031, receive a video (or receive media content that includes the video). The video (or the media content having the video) can be received via direct transmission, or can be accessed or retrieved using an address of the video (or an address of the media content having the video). In case the address of the media content that contains the video is received, the system can parse the address to access or retrieve the video. Here, the media content can include a text, an image, an audio, or other applicable content, in addition to the video.

While the operation 403 of the method 400 here is described as detecting target content for a video, the target content detection may be applied to detect target content from other aspects of the media content such as the text, image, audio, etc. For instance, if the system retrieves a webpage having a video, an image, and textual descriptions, the target content to alert the user can include: (1) one or more video frames, of the video embedded in the webpage, that include spoiler information of the movie, (2) the image or a portion thereof, from the webpage, that includes spoiler information (e.g., a movie scene captured by unauthorized source) of the movie, (3) textual descriptions, from the webpage, that include spoiler information of the movie in natural language, and/or other applicable type of spoiler information.

In some versions of these implementations, referring to FIG. 4B, at block 4033, the system can, at block 4033, determine whether the video (received alone or included the received media content) includes the target content. For instance, in case the spoiler information of a movie is determined as target content based on account data of an account, the system can determine whether the received video includes spoiler information of a movie. If the received video does not include the spoiler information of the movie, the system can determine that the video does not include the target content, and the system returns, at block 4031, to receive an additional video and determine whether the additional video includes the target content. If the received video includes the spoiler information of the movie, the system determines that the video includes the target content, and operations continue to block 4035, at which, the system determines a segment of the video that includes the target content. In some implementations, the video, when received by the system, already includes one or more segmentation marks (and/or is accompanied with metadata that describes the one or more segmentation marks). In this case, the system can rely on the one or more segmentation marks to divide the video into a plurality of video segments, or alternatively, use the one or more segmentation marks and the metadata that describes the one or more segmentation marks to determine the segment of the video that includes the target content (without dividing the video).

For instance, when the received video already include one or more predefined segmentation marks (or indicators) indicating a location of the target content in the video, the system can determine the location of the target content in the received media content based on the one or more predefined segmentation marks (or indicators). The one or more predefined segmentation marks, for instance, can be included in the metadata associated with the video by a creator of the video. As a non-limiting example, the one or more predefined segmentation marks can include a first predefined segmentation mark at 0:30 min, a second predefined segmentation mark at 2:00 min, and a third predefined segmentation mark at 3:30 min, thereby dividing the video (e.g., with a length of 5 min) into four video segments, i.e., a first video segment (0˜0:30 min, e.g., an introduction to software A), a second video segment (0:30 min˜2:00 min, e.g., an introduction to a first top feature of software A), a third video segment (2:00 min˜3:30 min, e.g., an introduction to a second top feature of software A), and a fourth video segment (3:30 min˜5:00 min, e.g., an introduction to a third top feature of software A). In this example, if the second top feature of software A is determined as the target content to alert a user, the system can use the second and third predefined segmentation marks to determine a location of the target content (i.e., the second top feature of software A) in the video.

In various implementations, the video can be received without any segmentation marks. In this case, to determine the segment of the video that includes the target content, the system can determine a starting point (e.g., 1:30 min for a 5-min long video, or the 5^{th} video frame for a video having 100 video frames) of the target content in the video and determine an ending point (e.g., 2:00 for a 5-min long video) of the target content in the video. The starting and ending points of the target content can be determined based on video frames of the video. Alternatively or additionally, the starting and ending points of the target content can be determined based on a transcription of the video, where the transcription of the video can be obtained by performing speech recognition of the video.

For instance, in some implementations, the system can process the video into a plurality of video frames, and from the plurality of video frames of the video, determine one or more video frames of the video that includes the target content. In these implementations, the video can be divided into a plurality of video segments (“segments”) based on the one or more video frames that include the target content, where the plurality of segments includes a segment containing (and sometimes only containing) the one or more video frames that includes the target content.

The aforementioned one or more video frames can be continuous or can be discrete. As a non-limiting example, a celebrity video showing an interview with actor R for movie X and other fan questions can be processed into video frame 1˜video frame 100, among which, video frame 10˜video frame 25 are determined to each include target content (i.e., spoiler information of movie X). In this example, based on the video frames 10˜25 including the target content (i.e., spoiler information), the celebrity video can be divided into three segments: a first segment including video frames 1˜9, a second segment including the video frames 10˜25, and a third segment including video frames 26˜100. Here, the second segment that includes the video frames 10˜25 can be labeled as target segment for which a content-alert label (sometimes referred to as “alert label”) and/or other alert interface (e.g., detailed alert indicating that the video includes spoiler information, a pop-up message alerting the user that the second segment is to be skipped, a confirmation message alerting that the user the second segment has been skipped, etc.) is generated.

Alternatively or additionally, continuing with the above example in which video frames 10˜25 are determined to include target content for a video having 100 video frames (i.e., with a length of approximately 4.2 s), the video having 100 video frames can be timestamped. For example, the video frame 10 can be assigned a first timestamp (e.g., 0.4 s) based on a location of the video frame 10 in the video, and the video frame 25 can be assigned a second timestamp (e.g., 1.4 s) based on a location of video frame 25 in the video. Subsequent remediating actions such as skipping the target content can be performed using the first and second timestamps, e.g., by skipping video frames within timestamps 0.4 s˜1.4 s. In these situations, the video may or may not need to be segmented.

As a varied example, a celebrity video showing an interview with actor R for movie X and other fan questions can be processed into video frame 1˜video frame 100, among which, video frame 10˜video frame 25 and video frame 45-video frame 70 are determined to each include target content (i.e., spoiler information of movie X). In this example, based on the video frames 10˜25 and 45-70 including the target content (i.e., spoiler information), the celebrity video can be divided into five segments: segment 1 including video frames 1˜9, segment 2 including the video frames 10˜25, segment 3 including video frames 26˜44, segment 4 including the video frames 45˜70, and segment 5 including video frames 71˜100. Here, segment 2 that includes the video frames 10˜25 can be determined as a first target segment, and segment 4 including the video frames 45˜70 can be determined as a second target segment. Subsequently, an alert label can be generated and displayed when the celebrity video is rendered via a display of a client device but before the celebrity video starts playing. Alternatively or additionally, other alert interfaces can be generated and/or rendered via the display.

For instance, a first pop-up message alerting the user that the second segment is to be skipped can be generated and rendered to the user when the video frame 10 is rendered (or a little earlier, say when video frame 8 or frame 9 is rendered), and a second pop-up message alerting the user that the second segment is to be skipped can be generated and rendered to the user when the video frame 45 is rendered (or a little earlier, say when video frame 42, 43, or 44 is rendered). The present disclosure is not limited thereto, and relevant descriptions of rendering alert label and/or other alert interface can be found elsewhere in this disclosure, for instance, in descriptions about the system performing one or more remediating actions.

In some other implementations, the system can obtain a transcription of a video (e.g., the aforementioned celebrity video), and perform natural language processing on the transcription to determine a first occurrence of the target content in the transcription and a last occurrence of the target content in the transcription. Based on the first and last occurrences of the target content in the transcription, a first and second video frames of the video can be determined, where the first video frame corresponds to the first occurrence of the target content in the transcription and the second video frame corresponds to the last occurrence of the target content. Here, the first video frame, the last video frame, and one or more intermediate video frames (if there is any) between the first and last video frames forms the segment of video that includes the target content. For the target content, one or more remediating actions can be performed, e.g., alert label and other alert interface can be generated and/or rendered visually (or audibly).

Referring back to FIG. 4A, in various implementations, at block 405, the system can, based on the target content to alert the user, perform one or more remediating actions. In some implementations, the one or more remediating actions can include a first remediating action of generating and/or rendering a content alert label that alerts the target content to the user. The content alert label can be generated based on the detection of the target content from the video and/or metadata (e.g., a title, short description, a note, a manually created classification label of the video, etc.), and after being generated, can be rendered to a user that encounters the video. It's noted that when, instead of (or in addition to) the video, media content is received and includes a text (or an image), the system can process the text (or the image) to determine/detect whether the text (or the image) includes the target content to alert the user, where a content alert label is generated based on the detection of the target content from the text (or the image) and can be rendered to a user.

If the system determines that the video includes no target content to alert the user, the first remediating action (i.e., generating a content alert label) will be bypassed (i.e., not performed), as well as any other remediating actions. As non-limiting examples, when the received media content is a video, the content alert label can be displayed (e.g., next to a title or other indicator of the video) for a thumbnail or a preview of the video (in case the video is displayed along with one or more other videos at the same user interface, see for example FIG. 2A). Alternatively or additionally, the content alert can be displayed at an interface particularly created or opened for the video (in case the video is displayed in a full-screen mode or is selected to be played from multiple videos, see for example FIG. 2B or FIG. 3A). The content alert label can be displayed next to a title of the video and/or can be displayed over video content of the video. In some implementations, the content alert label can be a symbol or an icon representing content alert (e.g., via color of the symbol, shape of the symbol, etc.), when hovered over, causes a name (e.g., “spoiler alert”, “known knowledge”, “content alert”, etc.) of the content alert label to be displayed. Alternatively or additionally, the name of the content alert label can be displayed within the symbol or the icon representing content alert, so that the user can readily understand the target content (be it spoiler information, knowledge already learned, or other undesired content) that the content alert label alerts for.

In some implementations, after the content alert label is generated, the content alert label can be rendered multiple times. For instance, the content alert label can be rendered to a user when the video including the target content shows up in a search result for a search conducted by the user, and can be rendered to the user at a user interface that exclusively displays the video (after the user selects to play the video). Optionally, the content alert label can be rendered whenever the video is displayed at a display. For instance, the alert label can be displayed next to the title of the video as long as the video is displayed.

The one or more remediating actions can include a second remediating action of generating and/or rendering an alert interface. The alert interface can be generated based on the target content to include: a textual portion that describes the target content to alert and/or location information of the target content, and/or a graphical element (e.g., the aforementioned slider control or other types of selectable element) that allows the user to turn on or turn off a content-skipping function that skips (e.g., hide, remove, or obfuscated) the display of the target content. Optionally or additionally, the alert interface can include a selectable button (e.g., “continue” button in FIG. 2B) for initiating the video, which when selected, initiates the playing of the video. Optionally or additionally, the alert interface can include the aforementioned content alert label, which may attract the user's attention via its appearance (color, shape, bolded words, etc.).

In some implementations, the alert interface (or the textual portion that describes the target content for alerting the user, alone) can be rendered automatically and visually (or audibly) before the video starts playing. Alternatively, the alert interface (or textual portion alone) can be displayed in response to detecting a cursor hovering over the alert label, and can disappear in response to the cursor leaving a region to which the alert label corresponds (e.g., a region over the alert label). In some implementations, alternatively or additionally, the alert interface (or textual portion alone) can be displayed before a video frame that corresponds to the starting point of the target content, of the video, is displayed. Optionally, in some implementations, the graphical element that allows the user to turn on or turn off the content-skipping function can be displayed whenever the user uses a cursor to hover over the alert label, or can be displayed at a fixed position of an interface that displays the video, and be displayed throughout the play of the video, and the present disclosure is not intended to be limiting. It's noted that the second remediating action of skipping the target content can be performed simultaneously with the first remediating action, or can be performed subsequent to the first remediating action. Or, the second remediating action can be performed, without performing the first remediating action.

The one or more remediating actions can include a third remediating action of skipping the target content. As a non-limiting example, given target content being a plurality of continuous video frames that includes an initial video frame at 1:30 min (representing the beginning of a video clip that provides spoiler information of a particular movie) and an ending video frame at 2:00 min (representing the ending of the video clip that provides spoiler information of the particular movie), video frames between 1:30 min and 2:00 min can be skipped so that the target content (i.e., spoiler information) is not received by the user that prefers not to see any movie spoilers. In this example, as soon as the initial video frame containing the spoiler information of the particular video is going to be played, the video can jump to play a video frame immediately subsequent to the ending video frame that contains the spoiler information of the particular video. In this case, the user, however, can be given the option to freely navigate the video to watch the skipped video clip, via the aforementioned slider control or other applicable control button. In case the target content is a plurality of video segments including two or more discontinuous video segments that contain the target content, the two or more discontinuous video segments can be skipped automatically, or the user can use the slider control to determine whether or not to skip each of the two or more discontinuous video segments individually.

In some implementations, the third remediating action of skipping the target content can be performed subsequent to the first and/or second remediating actions. In some implementations, the system can perform the third remediating action of skipping the target content automatically without performing the second remediating action of generating/rendering the alert interface. In this case, the system can perform a fourth remediating action, of the one or more remediating actions, to display one or more alert messages indicating that the target content will be and/or has been automatically skipped. The one or more alert messages can include, for example, the aforementioned first alerting message 303e (e.g., “2:38-4:16 will be skipped due to known knowledge”) in natural language, that alerts the target content to be skipped and/or a location (i.e., timestamps “2:38-4:16”) of the target content in the video. The alerting message 303e can be displayed along with the aforementioned graphical element (e.g., slider control) that allows the user to turn off the content-skipping function so that the target content will not be automatically skipped.

Alternatively or additionally, the one or more alert messages can include, for example, the aforementioned confirmation message 303f (e.g., “2:38-4:16 skipped due to known knowledge”) in natural language, that alerts the target content has been skipped and/or a location (i.e., timestamps “2:38-4:16”) of the target content in the video). Optionally, the confirmation message 303f can be displayed along with the aforementioned graphical element (e.g., slider control) that allows the user to turn on (or turn off) the content-skipping function to skip the target content. Optionally, the location (i.e., timestamps “2:38-4:16”) information of the target content in the video provided by the confirmation message 303f can allow the user to navigate the video using the progress bar 303d, in case the user changes her mind and decides that she would like to see the spoiler information.

Optionally, the one or more remediating actions can include a fifth remediating action of muting the video and/or obfuscating the video frames (or an image) containing the target content. The system can perform the fifth remediating action where skipping of the target content is not allowed/enabled. Optionally, the system can perform the fifth remediating action subsequent to the first or second remediating action. Optionally, the system can perform the fifth remediating action without performing the first and/or second remediating actions. In this case, the fourth remediating action can be performed to display one or more alert messages indicating that the target content will be and/or has been automatically muted (or obfuscated). As a non-limiting example, the first alert message, e.g., “spoiler information will be obfuscated for the slides”, can be rendered before rendering a slide in which the spoiler information first appears, and when the slide in which the spoiler information first appears (and/or other slides containing spoiler information, e.g., an image) is rendered, the spoiler information (textual or graphic) in the slide (and/or other slides) can be obfuscated.

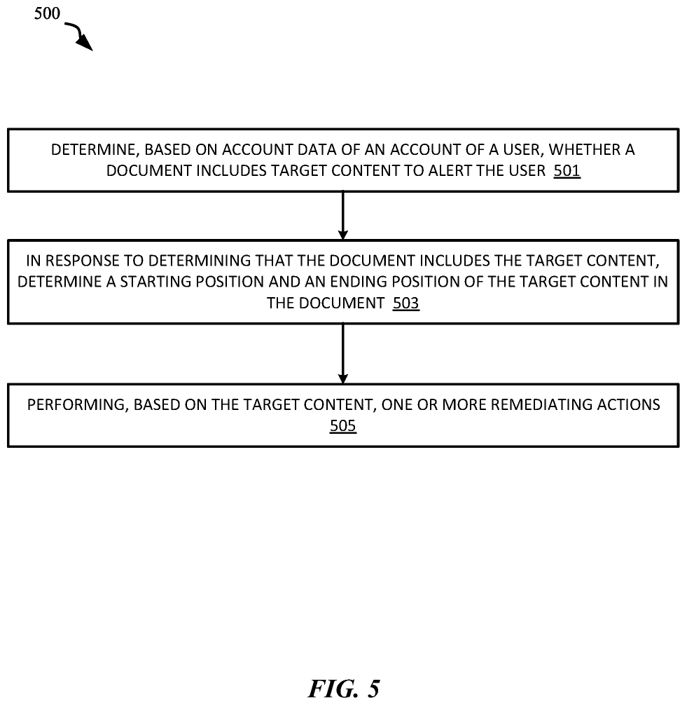

FIG. 5 depicts a flowchart illustrating another example method of alerting a user of undesired content, in accordance with various implementations. For convenience, the operations of the method 500 are described with reference to a system that performs the operations. The system of method 500 includes one or more processors and/or other component(s) of a client device and/or of a server device. Moreover, while operations of the method 500 are shown in a particular order, this is not meant to be limiting. One or more operations may be reordered, omitted, or added.

As shown in FIG. 5, in various implementations, a method 500 of alerting a user of undesired/target content can be performed by a system, where at block 501, the system determines, based on account data of an account, whether a document includes target content to alert the user. Here, the document can be, for example, a webpage, a PDF document, or any other applicable file. For instance, a webpage can include a text, an image, a video, or any other applicable embedded media content. The target content to alert the user can be content the user prefers not to encounter (whether or not the user has seen such content), and/or content the user is aware of. As a non-limiting example, the content the user prefers not to encounter can be determined based on preference data determined from the account data of the account. For instance, the preference data can include message data (e.g., “I am so excited to read book C when it arrives, please don't tell me anything before I read it”). In this case, spoiler information of book C can be determined from the message data as the content the user prefers not to encounter when browsing a document or other media content. Or, if the content-access application provides a function that allows a user to add certain type of data (e.g., “image or scene of car accident”) that the user prefers alerts for, the preference data can include application data of the content-access application that indicates the type of data (“scene of car accident”) the user prefers alerts for. In this case, textual descriptions, images, or video clips regarding a car accident can be determined from the application data as the content the user prefers not to encounter. Other than the message data and the application data of the content-access application, the preference data can also be determined or otherwise obtained from other applicable sources, and the present disclosure is not intended to be limiting.

As a non-limiting example, the content the user is aware of can be determined based on user historical data. For instance, the user historical data can include a browsing history of the content access application (and/or other applications) that records the time a user visited a webpage titled “feature A of speaker W you're gonna want to try”. In this case, the system can determine, based on such browsing history, textual descriptions, slides/images, or video clips that introduce feature A of speaker W as the content the user has aware of (i.e., content to alert the user), and the textual descriptions, slides/images, or video clips can be hidden, removed, or obfuscated in the document. Or, the user historical data can include a video uploaded by the user sharing “How to say thank you in Spanish”. In this case, an audio that teaches pronunciation of both “thank you” and “welcome” in Spanish can be determined to include the target content (i.e., pronunciation of “thank you” in Spanish) based on the shared video (“How to say thank you in Spanish”) in the user historical data. Examples here are for the purpose of illustrations, and are not intended to be limiting.

In various implementations, at block 503, the system can determine a location (e.g., a starting position and an ending position) of the target content in the document. For instance, when the target content to alert a user is image(s) of car accident, for a document including an image of a local car accident, the location (e.g., the coordinate information for the four corners of the image of the local car accident) of such image in the document can be determined.

In various implementations, at block 505, the system can perform one or more remediating actions with respect to the target content. Here, the one or more remediating actions can include a first remediating action of rendering an alert label. For instance, given the aforementioned example in which a webpage (or other document) that includes an image of a local car accident (as the target content to alert the user), an alert label can be generated based on the document including the image of the local car accident. In this case, after being generated, the alert label can be rendered at the webpage, adjacent to an address of the webpage, within a preview of the webpage at an interface showing a list of search results, etc.

Optionally, the one or more remediating actions can include a second remediating action of rendering an alert interface (or “alert window”). As a non-limiting example, when a user hovers over the aforementioned alert label that indicates a webpage includes target content the user may not want to see, the alert interface can pop up an overlay of the webpage preview, where the alert interface can include textual descriptions about the type of the target content the document includes. For instance, the alert interface can include a textual portion, e.g., “this webpage includes an image of a car accident, which can be skipped”. The alert interface for the document can include other elements similar to the aforementioned alert interface for a video, and repeated descriptions are omitted herein.

Optionally, the one or more remediating actions can include a third remediating action of skipping (hiding, folding, removing, automatically scrolling down a document, etc.) the target content from the document. For instance, content of the document may be re-organized to hide or remove the target content. In this instance, before the system performs the third remediating action of hiding or removing the target content from the document, the system can perform a fourth remediating action of generating or rendering one or more alert messages, such as an inquiry message to the user seeking user input as to whether or not the target content is allowed to be hidden or removed from the document.

As another example, the document can be automatically scrolled down in response to the occurrence of a starting point/position of the target content at a display via which the document is displayed. In this case, scrolling down can be automatically stopped when the ending point of the target content disappears from the display (indicating that the target content is longer rendered visually to the user). Optionally, the scrolling speed of the automatic scrolling-down of the document can be configured at a value for which the user cannot read the target content clearly. Optionally, before the system performs the third action of automatically scrolling down the document, the system can generate and render an inquiry message to the user, seeking user input as to whether or not the target content is allowed to be skipped by automatically scrolling down the document. It's noted that the examples described here are not intended to be limiting.

Optionally, the one or more remediating actions can include a fifth remediating action of obfuscating the target content (e.g., placing one or more black boxes over the target content, or blurring the target content to a degree a user cannot clearly sense what the target content is about). In this instance, before the system performs the third remediating action of obfuscating the target content in the document, the system can optionally perform the fourth remediating action of rendering the one or more alert messages, e.g., an inquiry message to the user seeking user input as to whether or not the target content is allowed to be obfuscated.

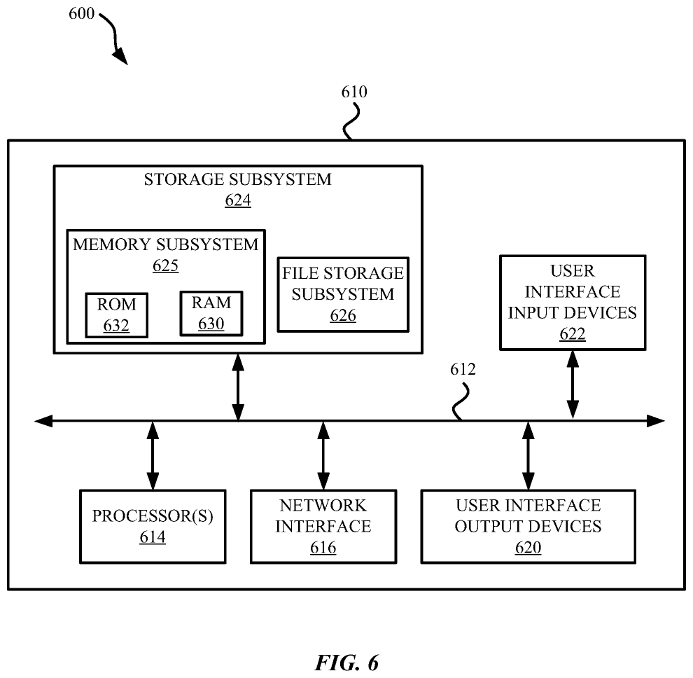

FIG. 6 is a block diagram of an example computing device 610 that may optionally be utilized to perform one or more aspects of techniques described herein. In some implementations, one or more of a client computing device, a cloud-based automated assistant component(s), and/or other component(s) may comprise one or more components of the example computing device 610.

Computing device 610 typically includes at least one processor 614 which communicates with a number of peripheral devices via bus subsystem 612. These peripheral devices may include a storage subsystem 624, including, for example, a memory subsystem 625 and a file storage subsystem 626, user interface output devices 620, user interface input devices 622, and a network interface subsystem 616. The input and output devices allow user interaction with computing device 610. Network interface subsystem 616 provides an interface to outside networks and is coupled to corresponding interface devices in other computing devices.

User interface input devices 622 may include a keyboard, pointing devices such as a mouse, trackball, touchpad, or graphics tablet, a scanner, a touch screen incorporated into the display, audio input devices such as voice recognition systems, microphones, and/or other types of input devices. In general, use of the term “input device” is intended to include all possible types of devices and ways to input information into computing device 610 or onto a communication network.

User interface output devices 620 may include a display subsystem, a printer, a fax machine, or non-visual displays such as audio output devices. The display subsystem may include a cathode ray tube (CRT), a flat-panel device such as a liquid crystal display (LCD), a projection device, or some other mechanism for creating a visible image. The display subsystem may also provide non-visual display such as via audio output devices. In general, use of the term “output device” is intended to include all possible types of devices and ways to output information from computing device 610 to the user or to another machine or computing device.

Storage subsystem 624 stores programming and data constructs that provide the functionality of some or all of the modules described herein. For example, the storage subsystem 624 may include the logic to perform selected aspects of the methods disclosed herein, as well as to implement various components depicted in FIGS. 1 and 2.

These software modules are generally executed by processor 614 alone or in combination with other processors. Memory 625 used in the storage subsystem 624 can include a number of memories including a main random-access memory (RAM) 630 for storage of instructions and data during program execution and a read only memory (ROM) 632 in which fixed instructions are stored. A file storage subsystem 626 can provide persistent storage for program and data files, and may include a hard disk drive, a floppy disk drive along with associated removable media, a CD-ROM drive, an optical drive, or removable media cartridges. The modules implementing the functionality of certain implementations may be stored by file storage subsystem 626 in the storage subsystem 624, or in other machines accessible by the processor(s) 614.

Bus subsystem 612 provides a mechanism for letting the various components and subsystems of computing device 610 communicate with each other as intended. Although bus subsystem 612 is shown schematically as a single bus, alternative implementations of the bus subsystem may use multiple buses.

Computing device 610 can be of varying types including a workstation, server, computing cluster, blade server, server farm, or any other data processing system or computing device. Due to the ever-changing nature of computers and networks, the description of computing device 610 depicted in FIG. 6 is intended only as a specific example for purposes of illustrating some implementations. Many other configurations of computing device 610 are possible having more or fewer components than the computing device depicted in FIG. 6.

While several implementations have been described and illustrated herein, a variety of other means and/or structures for performing the function and/or obtaining the results and/or one or more of the advantages described herein may be utilized, and each of such variations and/or modifications is deemed to be within the scope of the implementations described herein. More generally, all parameters, dimensions, materials, and configurations described herein are meant to be exemplary and that the actual parameters, dimensions, materials, and/or configurations will depend upon the specific application or applications for which the teachings is/are used. Those skilled in the art will recognize, or be able to ascertain using no more than routine experimentation, many equivalents to the specific implementations described herein. It is, therefore, to be understood that the foregoing implementations are presented by way of example only and that, within the scope of the appended claims and equivalents thereto, implementations may be practiced otherwise than as specifically described and claimed. Implementations of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present disclosure.

In some implementations, a method implemented by one or more processors is provided, and includes determining, based on account data for an account of a user, target content (e.g., content that is likely to be undesired by the user). The method can further include determining, based on processing a video, that a segment of the video includes the target content that is determined based on the account data. In response to determining that (a) the video, or a preview of the video, is being rendered by an application of a client device, (b) the account is used by the application and/or the client device, and (c) the video includes the target content determined based on the account data, the method can further include: causing one or more remediating actions, that are based on the target content, to be performed during rendering of the video or during rendering of the preview of the video.

These and other implementations of technology disclosed herein can optionally include one or more of the following features. In some implementations, the one or more remediating actions can optionally include: rendering a content-alert notification that alerts the user that the video includes the target content. The content-alert notification can be rendered at a user interface, of the application, during display of the preview of the video. Alternatively, the content-alert notification can be rendered before the video starts playing in the application and continues to be rendered during playing of the video.

In some other implementations, the one or more remediating actions can include: rendering an alert interface, wherein the alert interface includes a textual portion describing the target content. Optionally, the alert interface can include a selectable element that can be interacted with by the user to control whether the segment of the video is automatically skipped during playback of the video. For example, the selectable element can be pre-configured in a skip status (e.g., the aforementioned “ON” status), and when the selectable element is in the skip status, the segment of the video can be automatically skipped when the video is played. In some implementations, when the selectable element is interacted with to select a non-skip status (e.g., the aforementioned “OFF” status) in lieu of the skip status, the segment of the video is not automatically skipped when the video is played.

Optionally, the alert interface is displayed before the video starts playing. Alternatively or additionally, the alert interface is displayed before the segment, of the video, that includes the target content, is played.

Optionally, the one or more remediating actions can further include: rendering a content-alert notification that alerts the user that the video includes the target content. In this case, the alert interface can be displayed in response to detecting user interaction with the content-alert notification after the content-alert notification is rendered.

In some implementations, the one or more remediating actions can include automatically skipping, during playback of the video, the segment, of the video, that includes the target content, instead of displaying a selectable element that can be interacted with by the user to control whether the segment of the video is automatically skipped during playback of the video.

In some implementations, determining, based on processing the video, that the segment of the video includes the target content comprises: acquiring a transcription of the video; determining whether the transcription of the video includes one or more transcription portions that match the target content; and determining that the segment of the video includes the target content in response to determining that the transcription of the video includes the one or more transcription portions that match the target content.

In some implementations, determining that the segment of the video includes the target content, comprises: determining a starting point and an ending point, of the target content, in the transcription of the video; determining a first video frame, of the video, that corresponds to the starting point of the target content in the transcription; determining a second video frame, of the video, that corresponds to the ending point of the target content in the transcription; and determining a portion of the video between the first and second video frames as the segment, of the video, that includes the target content.

In some implementations, determining that the segment of the video includes the target content comprises: processing the video into a plurality of video frames, and determining, based on processing the video frames, that a subset of the video frames include the target content.

Optionally, the method can further include: determining a first timestamp indicating a start of the segment in the video and a second timestamp indicating an end of the segment in the video. In this case, causing the one or more remediating actions, that are based on the target content, to be performed can include: causing, during rendering of the video, a progress bar of the video to be rendered with an indication of the first and second timestamps to alert the user of a position of the segment in the video.

Optionally, causing the one or more remediating actions, that are based on the target content, to be performed can include: causing rendering of an alert message, that alerts the user that the segment will be automatically skipped, before the segment is automatically skipped. In this case, the alert message can include a selectable element that can be interacted with to control whether or not the segment is automatically skipped when the video is played.

In some implementations, a method implemented by one or more processors is provided, and includes: receiving, from a client device, target content that is determined based on account data of an account of a user of the client device; determining that a segment, of media content, includes the target content; and in response to determining that the media content is being rendered at the client device in association with the account of the user and in response to determining that the media content includes the target content determined based on the account data of the account of the user: causing the client device to perform one or more remediating actions based on the target content in the media content. The one or more remediating actions can include, for instance, automatically skipping the segment of the media content or automatically hiding the segment from the media content.

In some implementations, a method implemented by one or more processors is provided, and includes: determining, based on account data of an account of a user, target content. The method can further include, in response to access of a video via the client device: transmitting, to a server, an address of the video and the target content; receiving, from the server in response to the transmitting, one or more marks that identifies a segment, of the video, that includes the target content; and performing, based on the one or more marks received from the server, one or more remediating actions. Optionally, performing the one or more remediating actions includes: skipping, using the one or more marks, the segment that includes the target content when the video is being played. Optionally, the one or more marks indicates a starting time point of the segment in the video and/or an ending time point of the segment in the video.

In addition, some implementations include one or more processors (e.g., central processing unit(s) (CPU(s)), graphics processing unit(s) (GPU(s), and/or tensor processing unit(s) (TPU(s)) of one or more computing devices, where the one or more processors are operable to execute instructions stored in associated memory, and where the instructions are configured to cause performance of any of the aforementioned methods. Some implementations also include one or more non-transitory computer readable storage media storing computer instructions executable by one or more processors to perform any of the aforementioned methods. Some implementations also include a computer program product including instructions executable by one or more processors to perform any of the aforementioned methods.

1. A method implemented by one or more processors, the method comprising:
determining, based on account data for an account of a user, target content;
determining, based on processing a video:
that a segment of the video includes the target content determined based on the account data; and
in response to determining that (a) the video, or a preview of the video, is being rendered by an application of a client device, (b) the account is used by the application and/or the client device, and (c) the video includes the target content determined based on the account data:
causing one or more remediating actions, that are based on the target content, to be performed during rendering of the video or during rendering of the preview of the video.

2. The method of claim 1, wherein the one or more remediating actions include rendering a content-alert notification that alerts the user that the video includes the target content.

3. The method of claim 2, wherein the content-alert notification is rendered at a user interface, of the application, during display of the preview of the video.

4. The method of claim 2, wherein the content-alert notification is rendered before the video starts playing in the application and continues to be rendered during playing of the video.

5. The method of claim 1, wherein the one or more remediating actions include rendering an alert interface, wherein the alert interface includes a textual portion describing the target content.

6. The method of claim 5, wherein the alert interface includes a selectable element that can be interacted with by the user to control whether the segment of the video is automatically skipped during playback of the video.

7. The method of claim 6, wherein the selectable element is pre-configured in a skip status, wherein when the selectable element is in the skip status, the segment of the video is automatically skipped when the video is played.

8. The method of claim 7, wherein, when the selectable element is interacted with to select a non-skip status in lieu of the skip status, the segment of the video is not automatically skipped when the video is played.

9. The method of claim 5, wherein:
the alert interface is displayed before the video starts playing, or
the alert interface is displayed before the segment, of the video, that includes the target content, is played.

10. The method of claim 5, wherein the one or more remediating actions further include rendering a content-alert notification that alerts the user that the video includes the target content, and wherein the alert interface is displayed in response to detecting user interaction with the content-alert notification after the content-alert notification is rendered.

11. The method of claim 1, wherein the one or more remediating actions include automatically skipping, during playback of the video, the segment, of the video, that includes the target content.

12. The method of claim 1, wherein determining, based on processing the video, that the segment of the video includes the target content comprises:
acquiring a transcription of the video;
determining whether the transcription of the video includes one or more transcription portions that match the target content; and
determining that the segment of the video includes the target content in response to determining that the transcription of the video includes the one or more transcription portions that match the target content.

13. The method of claim 12, wherein determining that the segment of the video includes the target content, comprises:
determining a starting point and an ending point, of the target content, in the transcription of the video,
determining a first video frame, of the video, that corresponds to the starting point of the target content in the transcription,
determining a second video frame, of the video, that corresponds to the ending point of the target content in the transcription, and
determining a portion of the video between the first and second video frames as the segment, of the video, that includes the target content.

14. The method of claim 1, wherein determining that the segment of the video includes the target content comprises:
processing the video into a plurality of video frames, and
determining, based on processing the video frames, that a subset of the video frames include the target content.

15. The method of claim 1, further comprising:
determining a first timestamp indicating a start of the segment in the video and a second timestamp indicating an end of the segment in the video;
wherein causing the one or more remediating actions, that are based on the target content, to be performed comprises:
causing, during rendering of the video, a progress bar of the video to be rendered with an indication of the first and second timestamps to alert the user of a position of the segment in the video.

16. The method of claim 1, wherein causing the one or more remediating actions, that are based on the target content, to be performed comprises:
causing rendering of an alert message, that alerts the user that the segment will be automatically skipped, before the segment is automatically skipped.

17. The method of claim 16, wherein the alert message includes a selectable element that can be interacted with to control whether or not the segment is automatically skipped when the video is played.

18. A method implemented by one or more processors, the method comprising:
receiving, from a client device, target content that is determined based on account data of an account of a user of the client device;
determining that a segment, of media content, includes the target content; and
in response to determining that the media content is being rendered at the client device in association with the account of the user and in response to determining that the media content includes the target content determined based on the account data of the account of the user:
causing the client device to perform one or more remediating actions based on the target content in the media content,
wherein the one or more remediating actions includes automatically skipping the segment of the media content or automatically hiding the segment from the media content.

19. A method implemented by one or more processors of a client device, the method comprising:
determining, based on account data of an account of a user, target content;
in response to access of a video via the client device:
transmitting, to a server, an address of the video and the target content;
receiving, from the server in response to the transmitting, one or more marks that identifies a segment, of the video, that includes the target content; and
performing, based on the one or more marks received from the server, one or more remediating actions, wherein performing the one or more remediating actions includes:
skipping, using the one or more marks, the segment that includes the target content when the video is being played.

20. The method of claim 19, wherein the one or more marks indicates a starting time point of the segment in the video and/or an ending time point of the segment in the video.

21. (canceled)

22. (canceled)
